(19) United States
(12) Patent Application Publication
(10) Pub. No.: US 2003/0065740 A1
(43) Pub. Date: Apr. 3, 2003

(54) Real-time access to health-related information across a network

(76) Inventor: Karl Allen, Portland, OR (US)

Correspondence Address: James Y. Go, BLAKELY, SOKOLOFF, TAYLOR & ZAFMAN LLP, Seventh Floor, 12400 Wilshire Boulevard, Los Angeles, CA, 90025-1026, US

(21) Appl. No.: 09/967,210

(22) Filed: Sep. 28, 2001

(51) Int. Cl. G06F 15/16; G06F 17/60

(52) U.S. Cl. 709/217; 705/3

(57) ABSTRACT

The present invention provides for a real-time communication channel between a portable healthcare device and a remote information site. The health information system allows for transfer operations to be performed on-line and at any time. The health-related information is transmitted by one end of a network pathway and travels to a second end of the pathway. Along the pathway, the information is progressively intercepted by each of a series of segments having an interface to prepare the health-related information with appropriate data for reading at the next segment along the network pathway. The information is immediately processed and relayed back into the network towards its destination. In one embodiment, back-end services are provided for front-end applications occurring at a portable healthcare device, such as processing of raw health-related information generated at the portable healthcare device. In addition, other aspects of the present invention relating to the communication of health-related information between disparate segments to transfer the information.

### FIELD OF THE INVENTION

The present invention relates generally to a network pathway for transfer of health-related information. In particular, this invention is related to the real-time transfer of health-related information between a portable healthcare device and remote information site.

### BACKGROUND

There are growing uses for handheld devices in conducting health-related transactions that involve exchanges of electronic information across a network. Health professionals, such as physicians, medical staff, dentists, chiropractors, physical therapists, pharmacists, clinical trial specialists, biomedical researchers, health plan administrators, public health officials, etc., may use handheld devices in performing their daily workflow. Many of these tasks, such as writing prescriptions, checking laboratory results, dictating information and capturing charges are best performed as a patient is being cared for, i.e. at the point of care. However, real-time performance of these tasks is often not feasible with current communication systems because several parties must participate in the transactions. In addition, immediate transactions often require concurrent communication with and access to health-related information that is kept at a site located across a network. Present health communication systems do not provide convenient interaction between handheld devices and such remote information sites on a real-time basis.

There are numerous health-related transactions that may involve remote information sites, which may be facilitated by use of a handheld device. For example, the handheld device may be used for “e-prescribing” services to submit online claims to remote payers and to electronically route orders to pharmacies, including retail, online or mail order pharmacies. E-prescribing enables a health professional to write, order and renew prescriptions and to review information related to selected drugs. E-prescribing may reduce callbacks from patients and pharmacists, as well as decrease medical errors caused by illegible handwriting or adverse drug interactions.

The use of a handheld device to write prescriptions may also be advantageous for Pharmacy Benefit Managers (PBM's), which remotely manage the process of health insurance companies paying for prescriptions. Health-related information exchanged through the use of handheld devices may result in increase formulary compliance, resulting in PBM's receiving higher margins for filling drugs based on formularies. In addition, there may be improved drug compliance where prescription history information, such as whether a patient had filled a new prescription and whether a patient had received a refill within the prescribed time, is transferred.

Testing laboratories may also benefit from handheld devices used in electronic transactions related to lab services, i.e. e-lab services. There may be cost savings in being able to electronically receive orders for tests and send laboratory results. A health professional may use the device to write, modify and order laboratory tests, view test results, review information related to the selection of a laboratory test, etc.

With current systems, the process of transferring data between an external site and a handheld device is performed in batch off-line, where the data is processed at each segment of a network pathway according to its place in queue. Thus, delays may occur as the data waits its turn to be processed and passed to through the pathway. Furthermore, data generated at a handheld device is usually first transferred to a computer, such as through a docking system, where the data remains until the computer picks up the data and transfers it into the network.

In general, the shortcomings of the currently available methods for transferring health-related information are inadequate for real-time transmission between a handheld device and remote information site. In particular, previous methods do not provide an open pipeline for immediate processing and relay by the segments within a network pathway.

### BRIEF DESCRIPTION OF THE DRAWINGS

The present invention is illustrated by way of example, and not limitation, in the figures of the accompanying drawings in which:

FIGS. 1A and 1B are block diagram illustrating embodiments of a health information system, wherein FIG. 1A shows a series of interfaces transferring payload data across a real-time network pathway and FIG. 1B shows a user system that communicates with one or more remote information sites, in accordance with the teachings presented herein.

FIG. 2 is a block diagram example of a portable healthcare device to generate and transfer health-related information, in accordance with the teachings presented herein.

FIG. 3 is a block diagram example of an access server to process health-related information from a network pathway, in accordance with the teachings presented herein.

FIG. 4 is a block diagram depicting one embodiment of a health information system connecting multiple user systems to various ASP's, according to the teachings presented herein.

FIG. 5 is a flow chart depicting one method for transmitting health-related information by a segment of a network pathway, in accordance with the teachings presented herein.

FIG. 6 is a block diagram of a machine-accessible medium storing executable code and/or other data to provide one or a combination of mechanisms to generate and transfer health-related information, in accordance with one embodiment of the present invention.

### DETAILED DESCRIPTION

The present invention provides an end-to-end communication system that includes a real-time communication channel between a portable healthcare device and a remote information site. A network pathway having a series of interfaces allows for transfer operations to be performed on-line and at any time. Each interface is located at a segment of the pathway and prepares the health-related information payload for receipt at the next segment in the network pathway. Thus, the interface chain allows disparate segments to communicate the health-related information with each other along the network pathway. Each segment immediately prepares and sends the information as soon as it is received, permitting transfer to occur in real-time.

The health-related information that may be transferred through the system of the present invention is any information that has potential for being useful to a user at the portable healthcare device or at the remote information site. A user that may receive the health-related information may be any health professional, such as a healthcare provider, e.g. a provider of medical or health-related services and any other person or organization that furnishes, bills, or is paid for healthcare services or supplies in the normal course of business. Often times, the health-related information may pertain to a subject's health, well-being, or makeup. Subjects may include any person, entity or animal.

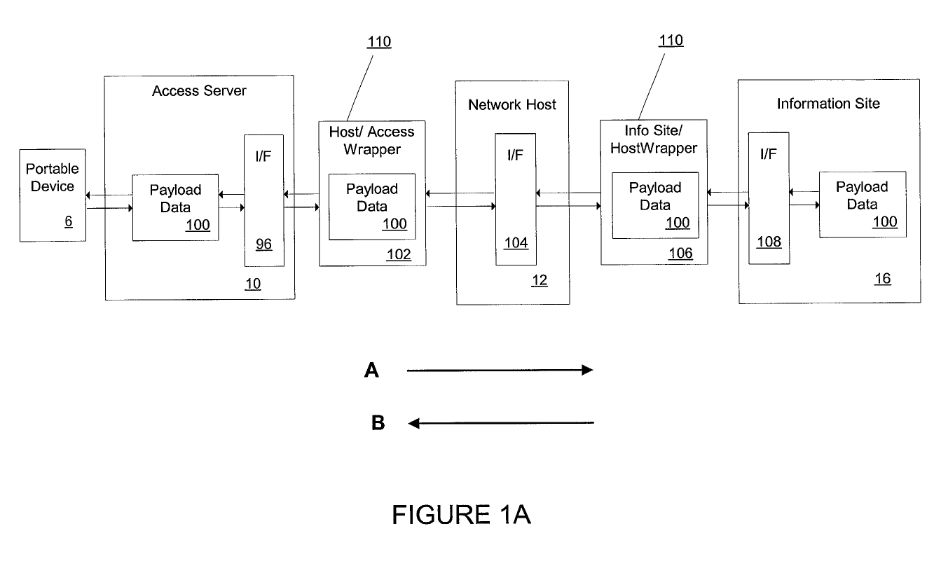

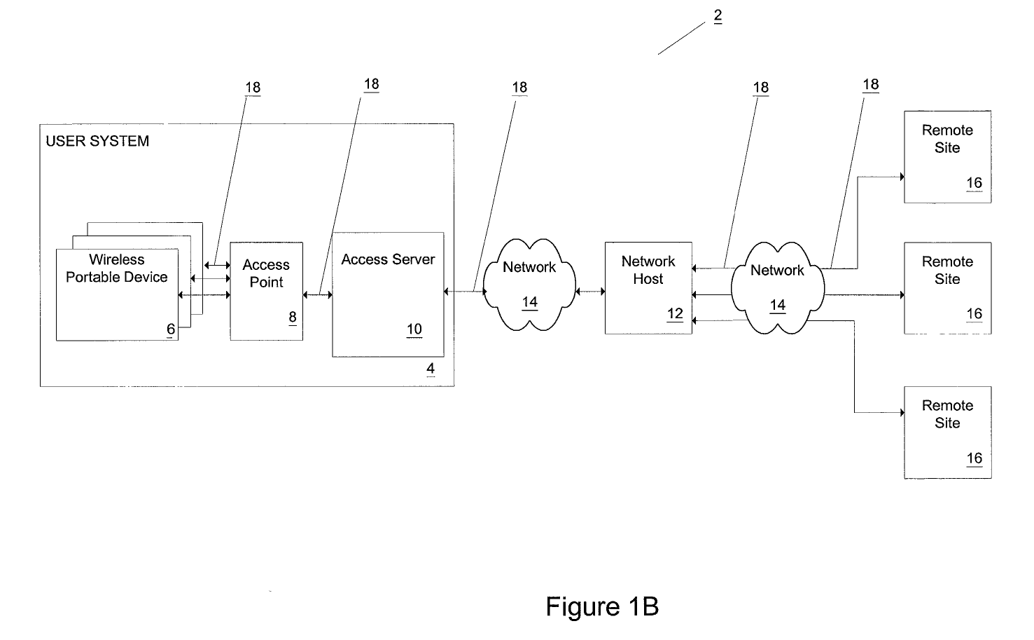

FIG. 1A depicts a network pathway with a global infrastructure to enable applications on the portable healthcare device to provide real-time data or for a remote information site to push real-time content to a portable healthcare device. The network pathway has various segments with interfaces for communicating the health-related information to a next sequential segment. Segments may include an access server, network host, remote information site, or other intermediary apparatus along the network pathway that intercepts and/or sends the information. From the time a first end of the pathway submits the health-related information, the information swiftly flows through all segments of the network pathway and all steps of the process are instantly performed to achieve seemingly instantaneous, e.g. within a few seconds of time or less, retrieval of information.

The health-related information is directed through the integrated health system as a payload data 100 in a transmission unit 110, e.g. data packet, that starts at either end of the pathway, i.e. the portable healthcare device 6 or remote information site 16. Any body of health-related information that is to be transferred through the system is packed into a single transmission unit, or more usually, a stream of multiple transmission units. The interfaces prepare the transmission unit for the next segment and, in most cases, do not alter the health-related information as released from the first end of the pathway. Some embodiments of a network pathway provides for bi-directional transfer of health-related information between the two ends of the pathway. Where the transmission of the health-related information is initiated from the portable healthcare device, i.e. first end, to the remote information site, i.e. second end, the transmission units travel in a direction A, and where the communication of the health-related information occurs initially from the remote information site, i.e. first end, towards the portable healthcare device, i.e. second end, the transmission units move in a direction B.

In the cases that the health-related information is sent in direction A, the health-related information flows through a server interface 96 of an access server 10. The server interface 96 places the payload data 100 in a wrapper 102 that contains the data recognizable by the next segment, such as the network host 12, in the network pathway. The network host 12 has a host interface 104 that prepares the payload data for reading by a remote information site and sends the information into the network 14. Usually, the host interface envelopes the payload data with a remote information site wrapper 106 having data, e.g. header information, acceptable by the remote information site. The host interface may remove any present wrapper 102 and provide a new wrapper 106 specific for the remote information site to receive the information. Oftentimes, each remote information site requires different proprietary wrapper information. Upon receipt of the transmission unit by the remote information site, the remote information site interface 108 removes the wrapper 106 to reveal the payload data 100.

Where the health-related information is moved through the network pathway in the direction B, the remote information site interface 106 prepares payload data 100 for sending into the network by placing the payload data into a wrapper 106 for web host access. The network host 12 intercepts the transmission unit and passes the unit through a host interface 104 that prepares the payload data for reading by the access server. The payload is placed in a wrapper 102 specific for the access server. The server interface 96 of the access server 10 strips away the wrapper 102 to reveal the payload data. The portable healthcare device receives the health-related information and usually immediately presents it to a user.

FIG. 1B illustrates an embodiment of an integrated health information system 2 having various segments along a network pathway 18. The network pathway 18 is an open network channel that provides a constant connection of the segments of the pathway so that health-related information may continually flow through the segments between any given portable healthcare device and a select remote information site. A user system 4 communicates with one or more remote information sites 16 through an external network 14 and along the network pathway 18, according to the present invention. Within the user system 4, at least one portable healthcare device 6 is to communicate with an access server 10 often through one or more wireless access points 8 along the network pathway 18. Also, a network host 12 in the network pathway 18 acts as an intermediary to provide the connection between the one or more user system and the remote site(s) 16.

Although FIG. 1B demonstrates a particular layout of integrated health information system, the scope of the present invention also anticipates other variations of the system to provide for information transfer. Any number of portable healthcare devices may be in communication with any number of remote information sites through any number of access points, including no access points, leading to one or more access servers, which may be arranged in various fashions within the network environment. An integrated health information system may include any number of network pathways that connect a plurality of portable devices to numerous remote information sites. In one embodiment, the access server and/or network host may also be shared by various other user systems.

The user system 4, e.g. a clinic, hospital, office, etc., includes at least a wireless internal network for the portable healthcare device or a group of portable healthcare devices. The user system may incorporate a wireless local area network (LAN) through which the components communicate. The user system may also include a wired internal network that communicates with the wireless internal network.

Through a wireless link within the user system, the portable healthcare device 6 provides for transmission and/or receipt of information. A health professional may use the portable healthcare device during the course of performing daily tasks, such as caring for a patient while simultaneously sending and/or obtaining health-related information “on the fly”. The portable healthcare device conveniently connects a health professional to sources outside of the user system, e.g. a remote information site, in real-time such that the transaction appears to the network pathway end that initiates the transaction to be instantly performed and with minimal interruption to the professional. In some cases, the health professional may use the portable healthcare device to send a request for specific health-related information from the remote information site and very quickly, e.g. within a few seconds or less, receive the requested information from the remote information site in response. The healthcare professional experiences the transaction in real-time due to the rapid turn around time.

The wireless portable healthcare device 6 may include a variety of devices that are easily moveable or mobile and that may submit and/or receive health-related information in electronic form via a network that is at least partially wireless. The portable healthcare device is usually a handheld computer that is of sufficient size to be used while a person is carrying it and often to be conveniently stored in a pocket.

The portable healthcare device is an intelligent wireless device, such as a personal digital assistant (PDA), e.g. the iPAQ® Pocket PC (from Compaq Computer Corporation, located in Houston, Tex.) and Jornada® (from Hewlett-Packard Corporation, located in Palo Alto, Calif.); a wireless telephone (e.g. cellular, personal communications services (PCS), etc.), a wearable computer, a pager, a BlackBerry (from Research in Motion, Ltd., located in Ontario, Canada) or other wireless intelligent device that is portable and may additionally have specific components for use in the integrated health information system. The device may be a wireless, portable computer system, such as a laptop, pocket computer, etc., e.g. a personal computer (PC), such as an Omnibook® (from Hewlett Packard Corporation, located in Palo Alto, Calif.), Vaio® (from Sony Electronics, Inc., located in Park Ridge, N.J.), Powerbook® (from Apple Computer, Inc., located in Cupertino, Calif.), etc. The devices listed are by way of example and are not intended to limit the choice of apparatuses that are or may become available in the portable wireless communications device field that may send or receive information without the need for wires or cables to transmit information, as described herein.

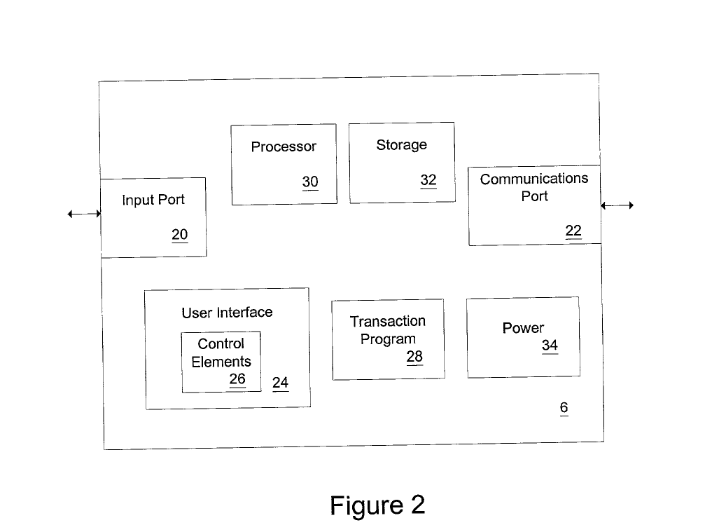

FIG. 2 depicts one embodiment of a portable healthcare device 6 having a communication port 22 to forward data to and receive data from components of the user system, e.g. the access server, access point(s) and/or other components along the network pathway. For example, the wireless communication port 22 may send health-related information into the wireless portion of the network pathway, which may be passed directly to an access server or through at least one access point that in turn transmits the information to the internal network for receipt at the access server.

The wireless communication port 22 communicates with the next receiving point, e.g. access point or access server, in the network pathway through a wireless communication segment of the pathway. The wireless communication port 22 may consist of a wireless radio and may communicate through carrier-based transmissions, such as infrared radiation or radio frequency (RF), usually according to any of the numerous communication standards used in the telecommunication industry. A common standard protocol is the IEEE 802.11b (Institute of Electrical and Electronics Engineering, std. 802.11b, published by IEEE, September 1999), WiFi™, Bluetooth, etc. In addition, various protocols may be used by the portable healthcare device to communicate within the user system, such as a network layer (Open Systems Interconnection (OSI) standards established by the International Standards Organization (ISO).

In some embodiments, such as where the portable healthcare device 6 is to send health-related information, the portable healthcare device also includes an input port 20 to enter health-related information that is to be sent to an access server. In some cases, the health-related information entering the system may be in a raw format, such as digital electronic signature data, fingerprint image data, eye image data, other biometric authorization data, or the like, or combinations thereof. This raw format data typically requires further processing by the portable healthcare device, access server or other component of the user system. In other cases, the health-related information is in a format that is useable by the remote information site.

A user interface 24 is often provided for presenting arriving or capturing departing health-related information for a user, such as on a display screen. The transfer of health-related information from across the network pathway and the presentation of information occur in real-time from the time the information leaves the remote information site and arrives at the user interface. Furthermore, the user interface may be for generating health-related information for transfer through the network pathway. The user interface 24 may be an audio interface, e.g. microphone, speaker, etc.; a visual interface, e.g. display; and/or a kinesthetic interface e.g. contact sensitive surface, deformable surface, etc. The user interface may also be coupled to the input port 20 to enter information for access by the portable healthcare device. In other situations no user interface is provided and the input port may directly connect to a health-related information source. The user interface may include one or more control elements 26 to generate health-related information.

There are various types of control elements 26 that may be include in the user interface. One type of control element is visible through an optional display screen (e.g. a liquid crystal display) that may be integrated with the portable healthcare device or coupled to the device. Such control elements may include buttons, pop-up or pull-down menus, scroll bars, iconic images, and text entry fields. The visual control elements may be activated by a variety of mechanisms, such as a touch pad, touch screen, pen-to-text data entry device, or activation mechanisms present on input/output devices, such as a keyboard and/or a mouse. Other control elements may be invisible to a display, such as voice or audio recognition elements, optical recognition elements, touch responsive elements, etc. There are a variety of interactive mechanisms to activate invisible and/or visible controls, such as voice or audio commands, touch movement or imprints, network signals, preprogrammed triggers within the system, instructional input from other applications, etc. All of the control elements described herein are by way of example and are not intended to limit the choices that are or may become available in the art.

One or more health transaction software program(s) 28 may provide prompts for the user to input desired transaction parameters through the user interface. For example, the transaction program may provide a list of types of health-related information for the user to request. The transaction program may also provide prompts for the user to submit patient information related to particular health-related information. The portable healthcare device may deliver numerous health-related transactions through various software packages, such as TouchWorks™ (from Allscripts Healthcare Solutions, located in Illinois).

The portable healthcare device 6 also includes processor 30, which may represent one or more processors to run an operating system and applications software that controls the operation of other device components. Some examples of processors are a StrongARM™ processor (from Intel Corporation, located in Santa Clara, Calif.), a Motorola® Power PC processor (from Motorola, Inc. located in Chicago, Ill.), etc.

A storage unit 32 is provided to hold data related to an operating system, applications, application data, and/or transaction-related data. The storage unit 32 may be any electrical, magnetic, optical, magneto-optical, and/or other type of machine-readable medium or device for writing and storing data. For example, the storage unit 32 may be one or more magnetic disks, FLASH memory, random access memory (RAM), such as dynamic RAM (DRAM) and static Ram (SRAM), etc. The amount of storage required depends on the type and amount of data stored.

Often a non-volatile storage, e.g. electrically erasable programmable read only memory, FLASH memory, or cache, is provided for the operating system and resident software applications. The storage unit may also be a hard drive, either integrated within the system, or external and coupled to the system. The storage unit may also be coupled to other types of multiple storage areas that may be considered as part of the storage unit or separate from the storage unit. These storage units 32 described are by way of example and are not intended to limit the choice of storage that are or may become available in the data storage field, as described herein.

A power unit 34 is included with the portable healthcare device to supply energy used to operate the device components. In one embodiment, the power unit 34 may be an energy storage area to hold power, which may be integrated into the device or removable and capable of being inserted into the device. For example; the power unit 34 may be a battery that is charged by energy from an external source. In another embodiment, the power unit 34 may be simply a power connector to couple with and direct energy from an external power source to the various device components rather than to store energy.

Furthermore, the portable healthcare device may also have various optional components, such as security measures to ensure permitted access to the internal network, protect transferred data, and the like. Security may be provided through encryption and/or authorization tools. Another optional component includes one or more biometric authentication element to confirm authorized users of the portable healthcare device.

The transmission exiting from the portable healthcare device may pass through one or more access points(s) 8, e.g. wireless LAN access point(s), that serve as a bridge between the access server and/or an existing wired network and the wireless device. The access point may also act as a router to pass along transmissions from one access point to another. One such access point is Intel PRO/Wireless 2011 LAN Access Point (by Intel Corporation, located in Santa Clara, Calif.).

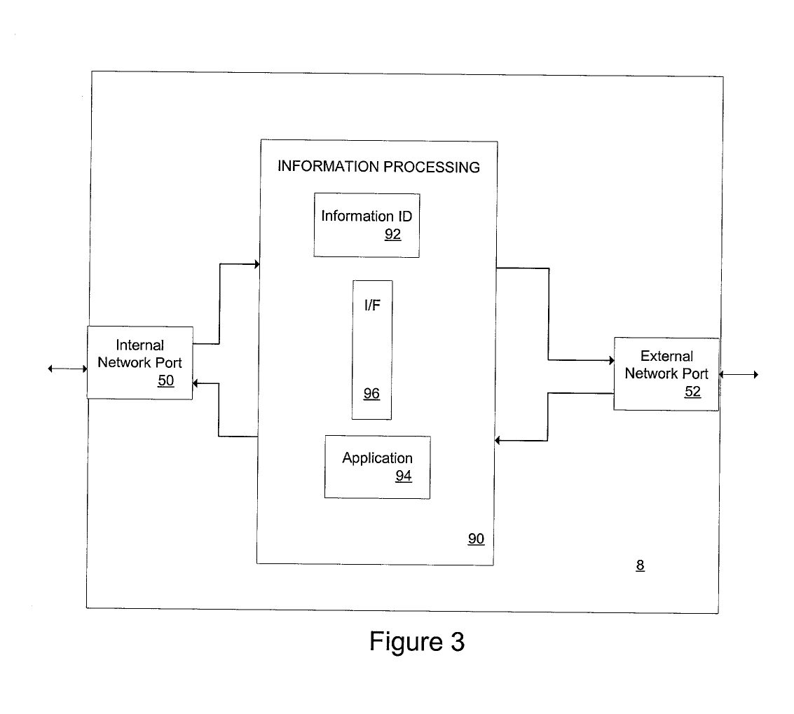

The access server functions as an interface for all communications leaving and entering a particular user system to conduct any necessary processing and translations. One embodiment of access server 10 in the user system is shown in FIG. 3. An internal network port 50 receives communication, e.g. health-related information promulgated from the portable healthcare device, of the internal network of the user system. Furthermore, the access server has an external network port 52 to transport and accept communications with a remote information site, such as through a network host.

The access server 10 has information processing components 90 for processing health-related information. An information identification unit 92 is provided to inspect information received from the network pathway and determine the type of the information. Furthermore, a server interface 96 prepares the health-related information to be in a suitable format for the next segment of the network pathway to receive the information.

The identification unit 92 may determine to where the information should be transferred along the network pathway. Such a determination may be made referencing an original request for the health-related information or as specified in the transmission unit. The receiving destination may be a requesting portable healthcare device, some other portable healthcare device, a designated electronic device or computer, a network host, a access point, a remote information site, a next segment toward a particular second end of the network, etc. In one embodiment, the information identification unit 92 may recognize the received information as a response to an earlier requested transaction or as a new transaction. For instance, the access server may maintain a log of references to requested transactions and the identification unit compares the incoming information with the references in the log.

Furthermore, the access server 10 may include an application unit 94 to determine the software application program to which the information belongs to and how the information should be entered into the appropriate application. The information may be associated with an application that is specific for the remote information site that sent it or multiple remote sites may be supported by one application program. In addition, a storage verification unit may be provided to ascertain whether the access server is to store the health-related information. Such storing of health-related information may be made in addition to transferring the information to a user, or in lieu of such transfer.

The access server usually also includes some conventional server components as known in the field. For example, a processor for controlling the other server components, and a storage unit for storing programs and data may be provided.

In still other embodiments of an access server, various other optional components may be present in the access server, which assist in transfer of health-related information. The access server may have a back-end processing unit for providing back-end services or support for a front-end application running on a portable healthcare device or other component of the user system. Such back-end processing unit may process raw health-related information generated by the portable healthcare device. For example, a speech recognition engine may be included to convert speech data collected by the portable healthcare device.

Another optional access server component is an authentication database for maintaining data to verify a person's identity. For example, the database, such as the consent database, may contain biometric authentication data, credentialing data, etc., which is associated with an authorization holder and/or an authorized user that may access particular health-related information. In addition, the access server may include various network components for encrypting data, for encapsulating data and for detecting and reacting to latency changes in network traffic

The user system communicates with to a network host 12 through external network 14. The network host 12 is the hub for all transmissions traveling to and/or from a user system or remote site 16.

The network host communicates with the user system and various remote sites through external network 14. The external network 14 is a public network (e.g. the Internet), a network that runs over a public network and provides for tunneling of data packets (e.g. a virtual private network (VPN)), or private (e.g. dedicated leased communication line, which may only be used by one user system and remote information site) network. Usually, the network provides for security in transport, as in a VPN where special encryption is used at the sending end and decryption at the receiving end.

During a transaction, one or more remote information site 16 may communicate health-related information in electronic form with various components of the user system and/or receive health-related information, from across the respective network pathway. Often, the remote information site retains the health-related information, may create the information immediately upon receiving a request, or has ready access to the health-related information stored elsewhere. In some embodiments, the remote information site is capable of providing responses to requests in real-time through the integrated health information system of the present invention.

Oftentimes, the remote information site is an application service provider (ASP) or similar back-end service center that collects data, acts upon the data and sends the data to a user system. The remote information site may be a healthcare clearinghouse that processes or facilitates the processing of data elements of health-related information. A health planner may also serve as a remote information site that provides, or pays the cost of, medical care, e.g. through an individual plan or group health plan. The information site may be a PBM, prescription service, prescription refill service, testing lab, transcription company, etc. For example, a PBM may have certain health-related information for use in determining whether an insurance plan or HMO should cover a prescription. Usually, there are a variety of remote information sites connected to the network pathway.

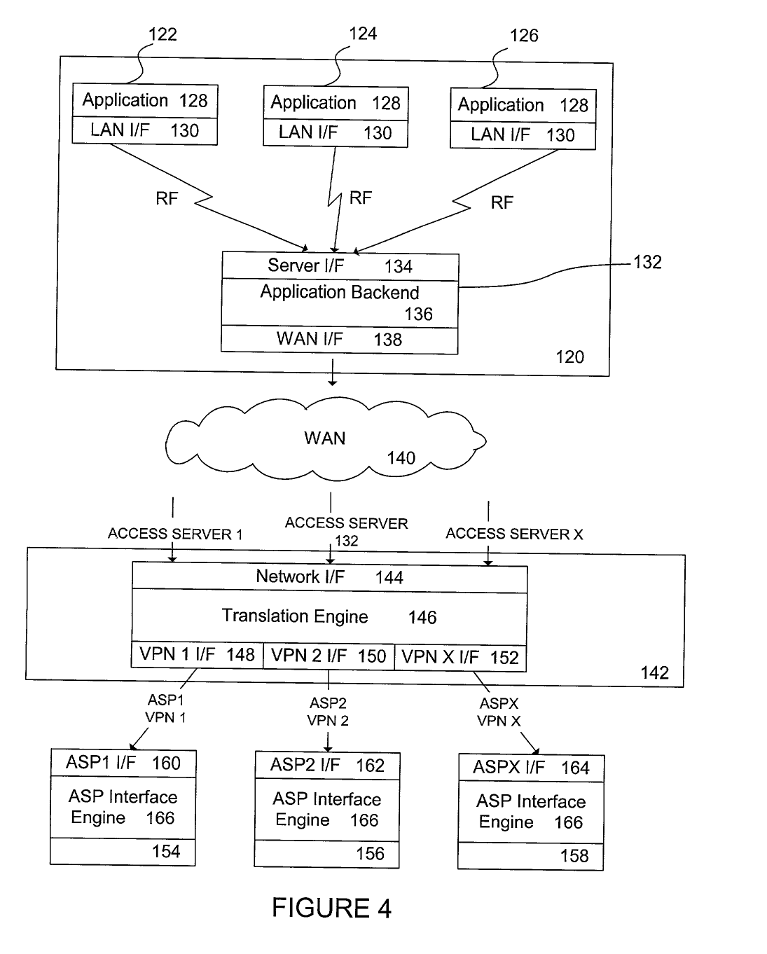

FIG. 4 illustrates one integrated health information system according to an embodiment of the present invention, where an access server receives health-related information from multiple portable healthcare devices and communicates the information to a network host, which in turn, is communicates to multiple ASP's that server as remote information sites. A user system 120 includes three portable healthcare devices 122, 124 and 126, each having an application 128. Each portable healthcare device also includes a LAN interface 130 for connecting across a LAN via radio frequency transmission to access server 132. The access server 132 has a server interface 134 to receive information sent from any of the devices 122, 124 and 126. In addition, an application back-end unit 136 provides support for the applications 128 running on the individual devices 122, 124 and 126. To prepare and pass the information into the WAN 140, a WAN interface 138 is provided in the access server.

From the WAN 140, a network host 142 receives the information from the access server 132, as well as from multiple other access servers 1 and X of access server 120 or various other user systems through a network interface 144. The network host serves as a central hub and gateway for all communications between user systems and external ASP's. A translation engine 146 of the network host is for translating between the data protocols used by the user systems and on any particular ASP. The network host provides separate VPN interfaces for each ASP in the system. Thus, VPN interface 148 communicates with ASP 154 through ASP interface 160, VPN interface 150 communicates with ASP 156 through ASP interface 162 and VPN interface 152 communicates with ASP 158 through ASP interface 164. Each ASP has an ASP interface engine 166 to translate incoming data to an internal format used by the ASP. The ASP interface engine 166 may also translate outgoing data from the internal ASP format to the format defined by the network host.

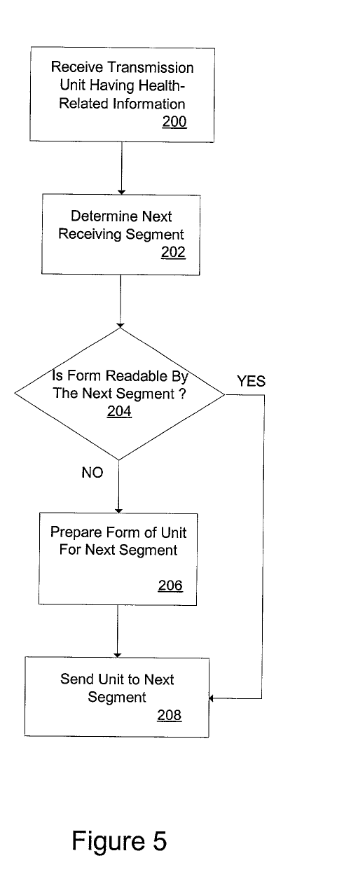

From the time the first end submits the health-related information, the information swiftly flows through all segments of the network pathway and all steps of the process are instantly performed to achieve seemingly real-time retrieval of information. FIG. 5 shows one embodiment of the health-related information transfer process as performed by a segment of the network pathway, according to the present invention. The segment receives health-related information from a previous segment of the pathway 200. The segment immediately processes the transmission unit and without delay. The segment determines the identity of the next segment that is to intercept the health-related information 202. The next segment may be determined by reading the data in a payload wrapper or other such data that specifies, the identification of the next segment, the information origin, a requestor of the information, and/or the ultimate intended destination of the information.

The transmission unit is further inspected to determine if its form is appropriate for the next segment to read 204. For example, the health-related information may be in a wrapper, e.g. proprietary header, having data that is specific for the current segment, but unreadable to the next segment of the pathway. If the form is not acceptable for the next segment, the unit is prepared to be in an appropriate form, e.g. placed in a wrapper and/or current wrapper removed 206. The health-related information is immediately sent to the next segment 208.

If there are more transmission units for a body of health-related information, the process may repeat for each transmission unit of a body of health-related information. In the alternative, for the remaining transmission units in a stream for a health-related information body, the process may assume the next segment and form of the first unit in the stream and skip the steps of determining the next segment 202 and form 204. Thus, in this case, the form of the unit may be directly changed if the first unit of the information stream required changing.

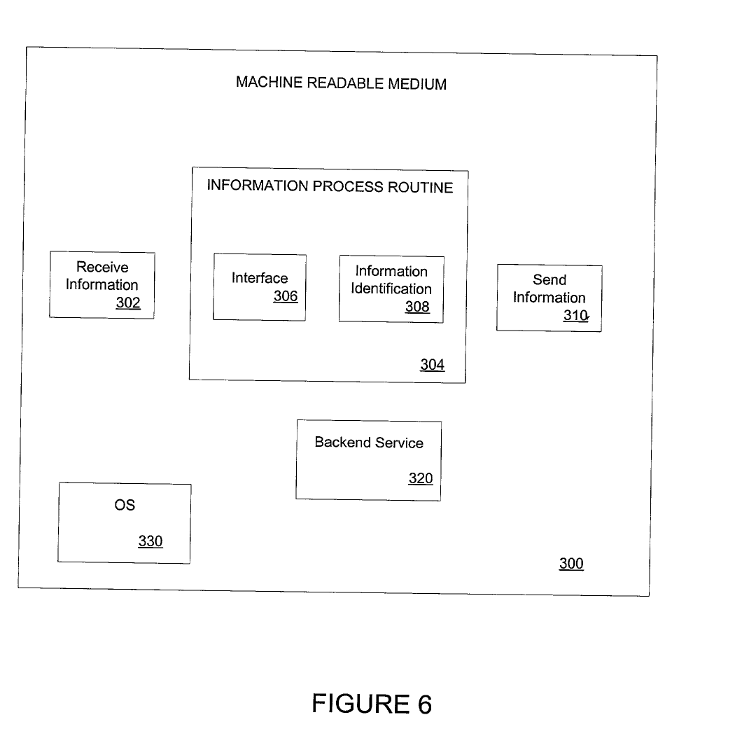

Various software components, e.g. applications programs, may be provided within or in communication with the access server that cause the processor or other components of the server to execute the numerous methods employed in conveying information through a network pathway. FIG. 6 is a block diagram of a machine accessible medium storing executable code and/or other data to provide one or a combination of mechanisms for intercepting, processing and forwarding information, according to one embodiment of the invention.

The machine-accessible storage medium 300 represents one or a combination of various types of media/devices for storing machine-readable data, which may include machine-executable code or routines. As such, the machine-accessible storage medium 300 could include, but is not limited to one or a combination of a magnetic storage space, magneto-optical storage, tape, optical storage, battery backed dynamic random access memory, battery backed static RAM, flash memory, etc. Various subroutines may also be provided. These subroutines may be parts of main routines in the form of static libraries, dynamic libraries, system device drivers or system services. The processes of various subroutines, which when executed, are described above with regard to FIG. 5.

The machine-readable storage medium 300 is shown having a receive information routine 302, which, when executed, obtains health-related information from across a network and immediately passes the information to an information processing routing 304.

The information processing routine 304 is for processing the receive information through various subroutines. An interface subroutine 306 is for preparing the health-related information with appropriate data for reading at the next segment. An information identification subroutine 308 may be executed for identifying the information and/or determining the appropriate next segment to receive the information. A send information routine 310 includes instructions for sending the processed information, in the form of transmission unit(s) into the network towards its ultimate destination.

The machine-readable storage medium 300 also is depicted as having a back-end support service routine 320 that supports an application running as a front-end on a previous segment of the network pathway. For example, the support service routine may conduct processing of raw health-related information generated through an application running on the portable healthcare device, e.g. speech recognition of voice health-related data, verification of digital electronic signature data, fingerprint recognition of fingerprint image data, retinal recognition of eye image data, other biometric authentication procedures, etc.

In addition, other software components may be included, such as an operating system 330.

The software components may be provided in as a series of computer readable instructions. When the instructions are executed, they cause a processor to perform the steps as described. For example, the instructions may cause a processor to accept information, process the information, forward the information, etc.

The present invention has been described above in varied detail by reference to particular embodiments and figures. However, these specifics should not be construed as limitations on the scope of the invention, but merely as illustrations of some of the presently preferred embodiments. It is to be further understood that other modifications or substitutions may be made to the described integrated health information system as well as methods of its use without departing from the broad scope of the invention. The above-described steps of transferring information through a real-time healthcare network pathway may be performed in various orders. Therefore, the following claims and their legal equivalents should determine the scope of the invention.

What is claimed is:

1. A method of transferring health-related information in real-time, the method comprising:
receiving health-related information transmitted from a first end of a network pathway between a portable healthcare device and a remote information site, the network pathway having a series of segments, each segment, immediately upon receipt, to prepare the health-related information with appropriate data for reading at the next segment along the network pathway towards a second end of the network pathway;
immediately passing the health-related information through a server interface to prepare the health-related information for reading at the next segment along the network pathway towards the second end; and
sending the health-related information across the network pathway for receipt at the second end.

2. The method of claim 1, wherein the preparing of the health-related information includes removing the health-related information from a wrapper and wherein the sending of the health-related information is across a wireless portion of the network pathway for receipt at the portable healthcare device.

3. The method of claim 1, wherein the preparing of the health-related information includes placing the health-related information into a wrapper acceptable for reading at the next segment along the network pathway towards the remote information site.

4. The method of claim 1, wherein the network pathway includes a virtual private network portion at the remote information site.

5. The method of claim 4, wherein sending of the health-related information is across a wide area network portion of the network pathway for receipt at the remote information site.

6. The method of claim 1, wherein one segment in the network pathway is a network host having an interface to unwrap the health-related information and place the health-related information into a wrapper acceptable for reading at the next segment along the network pathway towards the second end.

7. The method of claim 6, wherein the network host is further to translate the health-related information from a remote information site protocol to a user system protocol or from a user system protocol to a remote information site protocol.

8. The method of claim 1, further including back-end processing of raw health-related information generated through an application running on the portable healthcare device.

9. The method of claim 8, wherein the back-end processing is speech recognition of voice health-related data, verification of digital electronic signature data, fingerprint recognition of fingerprint image data, or retinal recognition of eye image data.

10. A method of transferring health-related information in real-time, the method comprising:
receiving, by a portable healthcare device, health-related information from across a wireless portion of a network pathway having a series of segments, each segment, immediately upon receipt, to prepare the health-related information with appropriate data for reading at the next segment along the network pathway from a remote information site and towards the portable healthcare device, and
presenting the health-related information in real-time for a user.

11. The method of claim 10, wherein the network pathway includes a virtual private network portion at the remote information site.

12. The method of claim 10, further including generating raw health-related information for further processing by an access server.

13. The method of claim 12, wherein the raw health-related information is voice data, digital electronic signature data, fingerprint image data, or eye image data.

14. A health system for real-time data transmission along a network pathway, comprising:
a) a portable healthcare device to send health-related information to and/or receive health-related information from across a wireless portion of a network pathway having a series of segments, each segment, immediately upon receipt, to prepare the health-related information with appropriate data for reading at the next segment along the network pathway between a remote information site and the portable healthcare device, and
b) an access server having an interface to prepare the health-related information for reading at the next segment along the network pathway, the access server to send the prepared health-related information across the network pathway.

15. The system of claim 14, wherein the network pathway includes a virtual private network portion at the remote information site.

16. The system of claim 14, wherein the remote information site is an application service provider.

17. The system of claim 14, further including a network host in the network pathway having an interface to unwrap the health-related information and place the health-related information into a wrapper acceptable for the next segment along the network pathway.

18. The system of claim 14, further including processing of raw health-related information generated through an application running on the portable healthcare device.

19. A computer accessible medium having stored therein a plurality of sequences of executable instructions, which, when executed by a processor, cause the system to:
receive health-related information transmitted from a first end of a network pathway between a portable healthcare device and a remote information site, the network pathway having a series of segments, each segment, immediately upon receipt, to prepare the health-related information with appropriate data for reading at the next segment along the network pathway towards a second end of the network pathway;
immediately pass the health-related information through a server interface to prepare the health-related information for reading at the next segment along the network pathway towards the second end; and
send the health-related information across the network pathway for receipt at the second end.

20. The computer accessible medium of claim 19, wherein the wherein the preparing of the health-related information includes removing the health-related information from a wrapper and wherein the sending of the health-related information is across a wireless portion of the network pathway for receipt at the portable healthcare device

21. The computer accessible medium of claim 19, wherein the preparing of the health-related information includes placing the health-related information into a wrapper acceptable for reading at the next segment along the network pathway towards the remote information site.

22. The computer accessible medium of claim 19, wherein the network pathway includes a virtual private network portion at the remote information site.

23. The computer accessible medium of claim 19, wherein one segment in the network pathway is a network host having an interface to unwrap the health-related information and place the health-related information into a wrapper acceptable for reading at the next segment along the network pathway towards the second end.

24. The computer accessible medium of claim 19, wherein the network host is further to translate the health-related information from a remote information site protocol to a user system protocol or from a user system protocol to a remote information site protocol.

25. The computer accessible medium of claim 19, further including additional sequences of executable instructions, which, when executed by the processor further cause the system to process raw health-related information generated through an application running on the portable healthcare device.

26. The computer accessible medium of claim 25, wherein the processing is speech recognition of voice health-related data, verification of digital electronic signature data, fingerprint recognition of fingerprint image data, or retinal recognition of eye image data.

27. A method of transferring health-related information in real-time, the method comprising:
receiving health-related information transmitted from a remote information site of a network pathway between a portable healthcare device and the remote information site, the network pathway having a series of segments, each segment including an interface to, immediately upon receipt, prepare the health-related information with appropriate data for reading at the next segment along the network pathway towards the portable healthcare device;
passing the health-related information through a server interface to remove the health-related information from a wrapper; and
sending the health-related information across a wireless portion of the network pathway for receipt at the portable healthcare device.

28. The method of claim 27, wherein the network pathway includes a virtual private network portion at the remote information site.

29. The method of claim 27, further including processing of raw health-related information generated through an application running on the portable healthcare device.

30. The method of claim 29, wherein the processing is speech recognition of voice health-related data, verification of digital electronic signature data, fingerprint recognition of fingerprint image data, or retinal recognition of eye image data.
